(19) United States
(12) Patent Application Publication
(10) Pub. No.: US 2002/0013721 A1
(43) Pub. Date: Jan. 31, 2002

(54) System, method and apparatus for integrated supply chain management

(76) Inventors: Alan Dabbiere, Atlanta, GA (US); Deepak Raghavan, Marietta, GA (US); Edward Capel, Marietta, GA (US)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 09/860,829

(22) Filed: May 21, 2001

Related U.S. Application Data
(60) Provisional application No. 60/206,153, filed on May 22, 2000.

(51) Int. Cl. G06F 17/60

(52) U.S. Cl. 705/7; 705/1

(57) ABSTRACT

A system, method and apparatus for integrated data communication between supply chain partners, such as factories, wholesalers, retailers and retail customers, transportation companies, etc. More specifically, a business community integration tool for providing to supply chain trading partners integrated, real-time access to such critical data as supply/inventory, demand, delivery status, etc., thereby improving operations and increasing Internet capabilities of trading partners by streamlining their inefficiencies and breaking down information barriers between them. The invention may be especially useful in retail supply chains associated with retail products including hard goods, soft goods, home furnishings, appliances, office products, apparel and footwear, grocery products and others. Integrated information may include remotely accessible corporate information, electronic product catalog contents, order and inventory status, etc.

### RELATED APPLICATIONS

The present invention claims the benefit of U.S. Provisional Application No. ______ filed on May 22, 2000, and entitled Retail Supply Chain Information Integration System.

### BACKGROUND OF THE INVENTION

1. Field of the Invention

The present invention relates generally to integrated information exchange. More specifically, the present invention relates to a business community integration tool for providing to manufacturers, suppliers, retailers and other trading partners integrated, real-time access to such supply chain data as supply/inventory, demand, delivery status, etc.

2. Related Art

In recent years, there has been dramatic growth in electronic commerce, particularly over such public networks as the Internet. With this growth has come increased competition between entities conducting business over the Internet. Such competition generates tremendous pressure on these entities to develop an edge over competing entities. Means for independent entities to achieve such an edge may include increased exposure, improved efficiency, etc. However, for entities that belong to business communities, a different dynamic often exists. For example, in business communities where supply chain management is a concern, additional complications may arise, often related to inter-communication amongst partnering entities. In these communities, the streamlining of value chain inefficiencies and the breaking down of information barriers become a must.

Attempts have been made to address such issues. However, proposed solutions tend to be company-centric, and thus are more applicable to individual entities. As applied to cross-entity environments, which depend on business process synchronization among trading partners, these solutions are limited. The attempted application of company-centric solutions to more complex problems that arise in attempting to integrate business communities often leads to disparate procedures and processes that are inflexible and costly to support. And current business processes tend to leave significant information gaps between trading partners. For example, a retailer may place an order with a supplier and get no information, such as allocation status and expected ship date, until the product has been or will shortly be shipped. This may occur days or even weeks after the order has been placed. As another example, retail buyers typically do not have access to information relating to inventory, such as time-phased availability to promise (ATP) information, often rendering decisions on merchandise rollout plans and others difficult to make.

Electronic data interchange (EDI) has been proposed as an external integration method. However, EDI tends to be more effective in certain limited environments, such as those involving primarily automated transactions, and less effective in the broader class of more diverse business community environments.

In addition, industry portals and independent trading exchanges are known. These entities typically focus on content management, presentation and transactions for a broad range of industry group requirements. These collaborations fail to address the problem of synchronizing and improving an efficiency of trading partners' business processes and systems. These collaborations also tend to experience heavy competition themselves.

What is needed is a system that provides integrated data access to supply chain partners, such as factories, wholesalers, retailers and retail customers, transportation companies, etc. Preferably, such a system would not compete with such entities as ITEs and others in the field, but would integrate them, providing the “plumbing” for integrated exchange of information, vastly improving collaboration in areas such as order tracking, item master information and inventory visibility. Furthermore, such a system should not only integrate data exchange between partners, but should preferably do so in real time such that the data exchange is timely and meaningful. Thus, trading partners could make more informed business decisions, and could make them earlier than is possible with known systems.

### SUMMARY OF THE INVENTION

The present invention includes a business community integration tool for improving operations and increasing Internet capabilities of trading partners by streamlining their inefficiencies and breaking down information barriers between them. The invention may be especially useful in retail supply chains, which typically include such trading partners as manufacturers, wholesalers, retailers, retail customers, transportation companies and trading exchanges. Associated retail products may include hard goods, soft goods, home furnishings, appliances, office products, apparel and footwear, grocery products and others. Integrated information may include remotely accessible corporate information, electronic product catalog contents, order and inventory status, etc.

The network of trading entities currently in existence is complicated and sometimes relatively unsophisticated. Particularly among manufacturers, which often do not have standardization and/or compliance pressures from their customers. Moreover, systems vary widely. Nonetheless, the present invention preferably provides the plumbing, technology enablement, communication means, etc., for many data integration initiatives, such as the business-to-business (B2B) electronic data interchange (EDI) initiative, amongst these widely varying entities. Because trading entities vary by such factors as size, geography, information technology (IT) experience, education and business arrangement, the invention is preferably adaptable to trading entities having systems of multiple qualities.

In one aspect, the present invention provides an interface with a less advanced system. Such a system may be a browser-based system-to-user interface, as may be required for integration with certain retailers. In one embodiment, the interface is employed as an extranet application for business partners, for example. The present invention may thus provide visibility into product production status, shipment information (ASN), carton labels for a streamlined receiving process, etc., which will often lead to improved warehouse management and in increase in inventory throughput. Further benefits may include increased inventory accuracy, reduced manual paperwork and data entry, forward visibility into supply chain, faster/more accurate receiving processes, fewer over-shipments, ability to measure shipper/carrier performance, reduced safety stock, provision of a basis for business process re-engineering and overall improved internal efficiency and customer service.

Suppliers or wholesalers, on the other hand, often feel pressure from their customers to provide greater accessibility to inventory, order status, etc. In another aspect, the present invention acts as a system-to-system interface. For example, the present invention may provide an interface between a manufacturer and a wholesaler that have technologically advanced systems.

In yet another aspect, the present invention provides an interface to peripheral trading partners, such as industry vertical portals, ITEs and consolidation portals. This interface is preferably implemented as a system-to-system interface, and preferably is further accessible to individual customers via the trading partners, such as through their web sites.

### BRIEF DESCRIPTION OF THE FIGURES

The accompanying drawings, which are incorporated in and constitute a part of this specification, illustrate embodiments of the invention and, together with the description, serve to explain the features, advantages, and principles of the invention. In the figures, like reference numbers indicate identical or functionally similar elements.

FIG. 1 shows block diagram of a data integration system of the present invention;

FIG. 2 shows a block diagram of a data integration system of the present invention;

FIG. 3 shows a block diagram of a system of the present invention having a data extraction layer; and

FIG. 4 shows a flow chart of a method of the present invention.

### DETAILED DESCRIPTION OF THE PREFERRED EMBODIMENTS

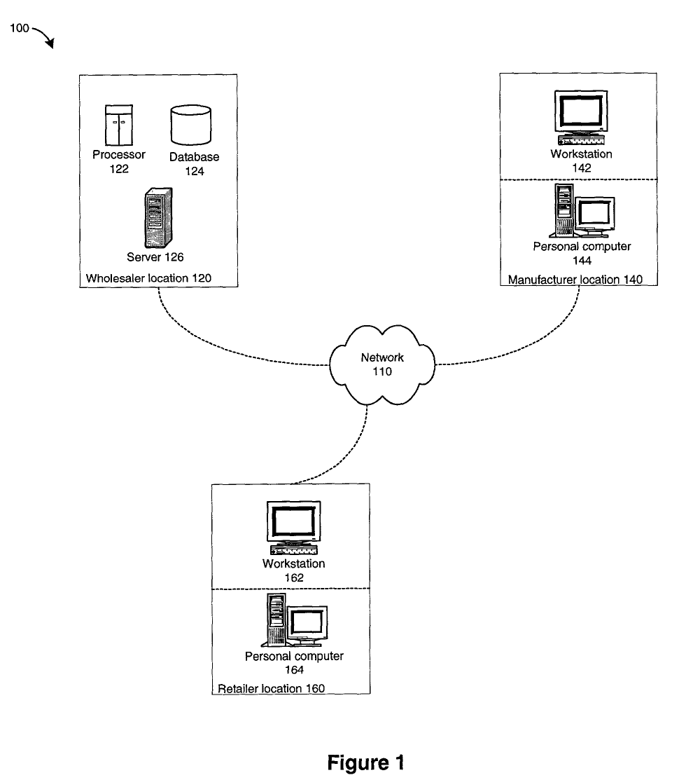

Referring to FIG. 1, an embodiment of the present invention is illustrated as a system 100. The system 100 includes a factory or wholesaler location 120, a supplier or manufacturer location 140 and a retailer location 160. The present invention, however, encompasses systems having more, fewer and differing entities. For example, the system may include only a manufacturer and a retailer. Alternatively, the system may include a wholesaler, and an entity acting both as a supplier and a retailer. The system may also include entities dealing in raw materials, such as fabrics and accessories, and others.

In one embodiment, the system 100 of the present invention is designed as a wholesaler-centric system. That is, the wholesaler location 120 includes means for bulk data storage, server capability, etc., and controls access by any participating manufacturer locations 140 and/or retailer locations 160, and any other participating entities, to supply chain and related information. Thus, the exemplary wholesaler location 120 of FIG. 1 is illustrated as including a processor 122, a database 124 and a server 126. And although the system has been illustrated for a wholesaler-centric solution, the system 100 may be implemented and supported by any trading partner, or even an independent entity.

The exemplary manufacturer location 140 is illustrated as including a workstation 142 and/or a personal computer 142, such as, but not limited to, an IBM compatible, Macintosh, etc. Likewise, the exemplary retailer location 160 is illustrated as including a workstation 162 and/or a personal computer (PC) 164. In this embodiment, the manufacturer location 140 and retailer location 160 may only be enabled for accessing/providing data over a network.

While the trading partner locations have been illustrated as having particular technological features, it should be noted that any participating location might include any or all of the illustrated features and/or others known in the art. Of course, the illustrated system 100 is merely exemplary as well, and thus, the system 100 need not include all of the entities illustrated. Furthermore, the system 100 may include multiple instances of any or all of the entities illustrated and may include additional related or unrelated entities as desired.

As is further illustrated by FIG. 1, the wholesaler location 120, the manufacturer location 140 and the retailer location 160 are coupled via a network 110. In one embodiment, any or all of the wholesaler location 120, the manufacturer location 140 and the retailer location 160 include a portion configured as an industry portal (a.k.a. vertical portal or vortal) accessible over the network 110. This network 110 may be any means for intercommunication, including a hardwired or wireless network, or a combination thereof, such as the worldwide network broadly defined as the Internet. Furthermore, the present invention may be implemented on a network that is accessible by the public, or on a private network, such as a private intranet or extranet, local area network (LAN) or wide area network (WAN), for example. In a preferred embodiment, the present invention is implemented on a public network such as Internet, while utilizing a security model or other interface that limits access to particular information to intended parties only. For example, login and password information may be required to access the system. In addition, a secure communications protocol, such as secure hypertext transfer protocol (HTTPS), may be employed if desired. As used herein, the terms ‘network’ and ‘Internet’ are intended to encompass not only the hardwired network, but also any means of interfacing therewith (e.g., cell phones, personal digital assistants (PDAs), satellite, and others)

In general, the present invention preferably enables a real-time collaborative communication between various entities via various means of communication. Preferably, in interfacing systems of trading partners, intersystem communication is based on a standard communications format, such that multiple parties, particularly sophisticated parties, may be readily integrated into the system. However, in interfacing a business partner or typical individual customer having a less sophisticated system (having only a network connection and a browser, for example), a system of the present invention is preferably configured such that an interface may be alternatively employed, such as via an extranet application.

The flexibility provided by such an arrangement preferably allows a system of the present invention to extract data from underlying, pre-existing partner systems that may be widely variable. These underlying systems may include enterprise resource planning (ERP) systems, warehouse management systems (WMS), trading management systems (TMS) and others. This data may then be integrated without a need for such traditional measures as telephone calls and document facsimile, thus allowing the information to be tracked and shared by partnering systems with minimal manual effort. Once integrated, access may be provided not only to the trading partner systems, but also to portals and exchanges. In doing so, the present invention is able to not only provide this information, but also to further provide an industry-specific infrastructure to these entities.

In one embodiment, the present invention acts as a system-to-system interface. For example, the present invention may provide an interface between a wholesaler location 120 and a retailer location 140. As discussed above, where trading partners are sufficiently technologically sophisticated in their information systems, a standard communication format may be utilized. In one embodiment, for example, the generalized markup language (SGML), specifically the extensible markup language (XML), is used. More specifically, the usage of such a format as XML may conform to a further standard or framework as XML BizTalk or another known to one skilled in the art.

In another embodiment, the present invention provides an interface between a wholesaler and retailer. Such an interface may also be system-to-system, or may be a system-to-user interface. In one embodiment, the interface is employed as an extranet application for business partners having only a browser-based system, for example. These partners may thereby be granted access to an item catalog and to such information as order status, etc. As will be further discussed below, the wholesaler in this example may control visibility to certain or all retailers and/or others having access to such information as inventory and/or allocation or available to promise (ATP) items. In addition, retailers may set alerts regarding a status of any of the above parameters or others.

In yet another aspect, the present invention provides an interface to peripheral partners, such as industry vertical portals, ITEs and consolidation portals. This interface is preferably implemented as a system-to-system interface, but is preferably further accessible to users via the trading partners.

Regardless of a communication means provided, information such as, but not limited to, capacity, demand, price, substitute availability, production status, order status, delivery status, catalog items, inventory visibility, container advance shipping notices (ASNs), etc., may preferably be accessed and shared among trading partners. Information may also be provided, if desired, via infomediaries, ITEs, various portals such as industry vertical portals and consolidation portals, and others. Methods of the present invention for information access and exchange will be further discussed below.

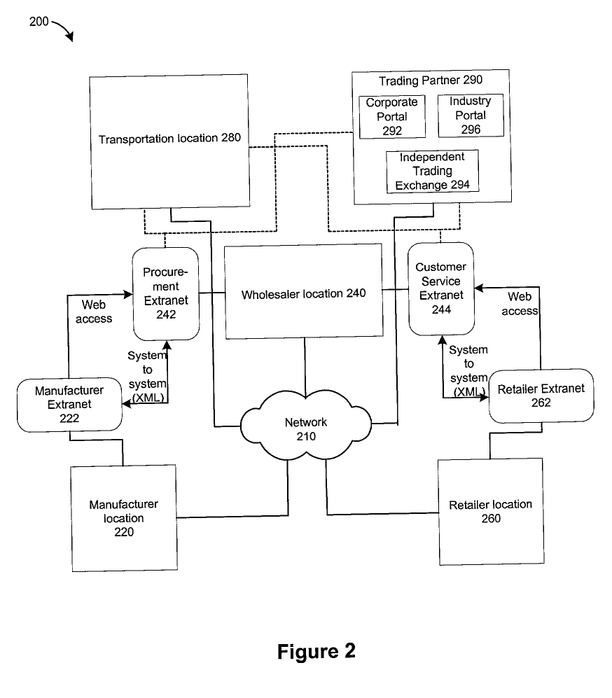

FIG. 2 illustrates an embodiment of a system of the present invention in greater detail as a system 200. Like the system 100 of FIG. 1, the system 200 may include a manufacturer location 220, a wholesaler location 240 and a retailer location 260 enabled for communication over a network 210. The system 200 is preferably further accessible to entities including a delivery or transportation location 280 and a trading partner location 290 coupled to the network 210. As illustrated, the trading partner location 290 may include such entities as a corporate portal 292, an independent trading exchange (ITE) 294, an industry portal 296, as well as other industry trading partners as desired. Note that illustrated supply chain trading partners, such as the manufacturer location 220, the wholesaler location 240 and the retailer location 260, may be independent, or may themselves, in whole or in part, be party to their own trading exchanges. Thus, the system 200 may include independent entities, may include entities that are a part of a single trading exchange, may include multiple trading exchanges themselves, etc. The system 200 may further be accessible to the general public, either through independent means or through one or more of the illustrated entities. Preferably, partners of the system 200 limit the data to which members of the public, as well as other partners and other participating entities, have access.

In a preferred embodiment, the system 200 is implemented as a software-based package or comparable system integration tool. The system 200 may be supported at any or all of the manufacturer location 220, the wholesaler location 240, the retailer location 260, the transportation location 280, the trading partner location 290 and at locations of any other entities that are a part of the system 200.

Alternatively, the system 200 may be implemented as a hosted application, such as by an application service provider (ASP), for example. Through the use of a wide-area-network such as the Internet, the present invention may be implemented without incurring the overhead, functional limitations and expenses of traditional data integration systems. And through the combined use of a standardized protocol, such as XML, and browser-based technology, a more universal system is made possible that could allow independent trading partners of varying sizes and technological abilities to be integrated more easily and efficiently. Further details of potential architectures and associated functionality of systems of the present invention are hereinafter described.

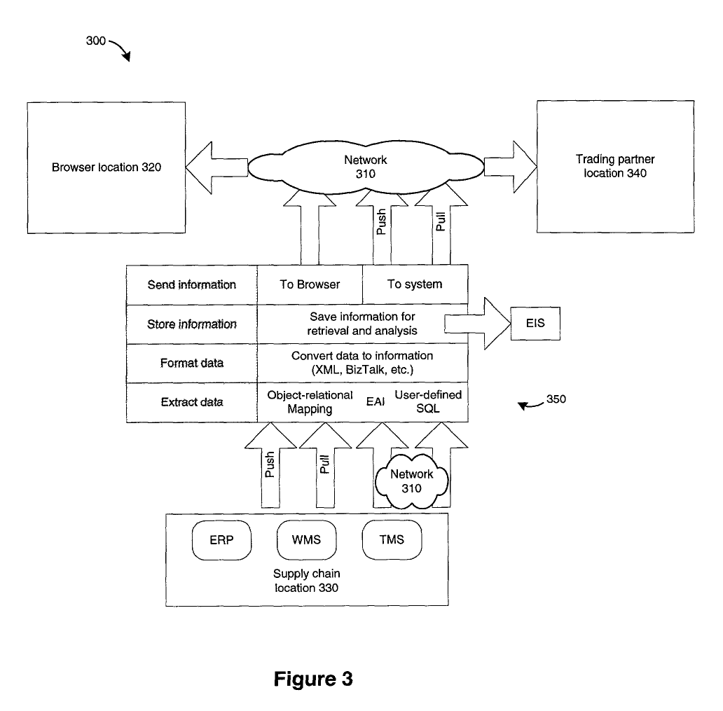

Implementation of one embodiment of the present invention is illustrated in greater detail in FIG. 3, which shows a system 300. The system 300 has a browser location 320; a supply chain location 330, which may be, for example, a manufacturer location, a wholesaler location, a retailer location, etc.; and a trading partner location 340. Each of these locations is preferably coupled to the others by a network 310. Again, a typical system 300 of the present invention will include multiple supply chain locations 330.

The illustrated exemplary system 300 of FIG. 3 includes a highly configurable, real-time, data extraction layer 350. The data extraction layer 350 preferably allows the system 300 to provide great flexibility, in that entities that have systems supported by widely varying technologies may nonetheless be integrated for data exchange by the system 300. For example, the data extraction layer 350 is preferably capable of pulling data from entity back-end systems using standard methodologies, sequential queried logic (SQL) statements, open data base connectivity (ODBC) connections and standard linkages to such back-end systems (BES) as systems, applications and products (SAP), Java development environment (JDE), pick management systems (PkMS), Internet protocol (IP) based systems, etc.

A data extraction layer 350 is provided for facilitating communication between the respective portion and remaining portions of the system. The data extraction layer 350 is preferably coupled to at least one supply chain location 330, such as the manufacturer location 220, the wholesaler portion 240 or the retailer portion 260 of FIG. 2, etc. In one embodiment, for example, the data extraction layer 350 comprises a back-end interface for extracting raw data from the portion to which the data extraction layer 350 is coupled. The extracted raw data can then be converted, in real time, to a format readable by remaining portions of the system 300.

In one specific embodiment, the data extraction layer 350 includes a pull system for translating data from a format of a legacy system to a more standardized format, such as the Extensible Mark-Up Language (XML) format. The format of the legacy system may be very basic, such as a browser-based system of the browser location 320, which may be adapted only for entry of plain text data, for example. The translation may occur automatically, or at a command of a user.

The following is an illustrative example of a real-time, collaborative exchange of information that may occur between entities practicing the present invention. This example illustrates the use of the invention to improve collaboration in the retail supply chain. Exemplary participants here include Tommy Hilfiger (a supplier to retailers), Federated Department Stores (a retailer), an apparel manufacturer (in Mexico), and a domestic transportation carrier. Additional participants may include a freight forwarder, a freight consolidator, a customs broker, a customs agency, a freight de-consolidator, retail customers, etc.

As a supplier to major retailers throughout the United States and the rest of the world, providing branded apparel and footwear products, Tommy Hilfiger may wish to obtain some of its sports apparel merchandise from the manufacturer in Mexico. Federated Department Stores (FDS), which includes Macy's, for example, is a national retailer that owns several chains of department stores throughout the United States. For this example, it is assumed that FDS retailers sell a multitude of products including apparel, footwear, fashion accessories, and furniture. It is further assumed that FDS wishes to acquire from Hilfiger at least some of the Hilfiger brand sports apparel.

In preparation for the winter season, buyers for the various divisions within Federated Department Stores (FDS) may begin developing a product plan months in advance. In this example, further assume that, based upon an analysis of fall sales figures, market research, and an unseasonably warm beginning to the winter, for example, Macy's buyers have determined that the Tommy Hilfiger line of men's sports apparel will continue to be very popular in the southeastern U.S. for at least the first month or two of winter. For simplicity, it is assumed that there is one main buyer at Macy's that is responsible for ordering all of the men's sports apparel for all of the Macy's stores in the southeastern U.S. Traditionally, buyers have not had the ability to react quickly to changes in market demand or rapidly developing fashion trends. Such ability may be advantageous, as the buyer could act on this information quickly in order to take advantage of the developing trends and conditions. The present invention may provide this opportunity.

In this embodiment, we will assume that a system 100 of the present invention is supported by the wholesaler Tommy Hilfiger. As noted above, in our example, the buyer already has a sense for which products will continue to sell well into winter. With this information the buyer may log into the system 100 supported by Hilfiger to obtain information about the specific products needed. The buyer may be located, for example, in the Macy's office in New York City and can use his personal computer (PC) to access an Internet web site affiliated with the system 100, enabling retail supply chain collaboration with the supplier Tommy Hilfiger.

Based upon identifying information (i.e. credentials such as organization, role, department, personal ID combination, etc.) entered by the Macy's buyer, the buyer may be given immediate access to all of the products in his area of interest (men's sports apparel). In accordance with wishes of a Hilfiger administrator, the buyer may be prevented from viewing information related to products outside his or her particular area (e.g. products for other departments and products offered to other Tommy Hilfiger customers). The system 100 may also ensure that other departments and other competitors do not have access to product information such as product pricing and inventory information intended specifically for the Macy's buyer. In this manner, participating entities may strategically tailor buying and selling prices, preferences, etc., depending on a particular entity or transaction, for example. In one embodiment, an entity may control not only absolute access (that is, access versus non-access), but also a quality or quantity of information as viewed by other entities. For example, a supplier may control inventory visibility such that a first entity sees inventory as zero, while a second entity (that the supplier prefers, perhaps due to a known willingness to pay a higher price, for example) sees inventory availability. In a similar manner, a buyer may manifest its own willingness to pay a higher price to certain sellers (for quality reasons, for example) by displaying a greater demand or buy price to those preferred sellers.

The information provided to the buyer is preferably in real time, based upon the actual information in various systems and locations within the Tommy Hilifiger (supplier) organization. Product offering and product pricing information, for example, may be obtained through real-time access to Hilfiger's Enterprise Resource Planning (ERP) system (see e.g., FIG. 3). Product availability information may be obtained through real-time access to Tommy Hilfiger's existing Warehouse Management System (WMS). Upon extracting the information from these various systems in real time, the information is preferably displayed. In one embodiment, the information is assembled into the Extensible Markup Language (XML) format and then displayed to the buyer. The buyer may then view the final presentation of the information in any desired manner, such as by accessing the information as an XML web page using an Internet browser on the buyer's computer system.

In this embodiment of the system 100, the buyer is able to access the system 100 and view the desired products and the associated pricing and inventory information. Assume the buyer learns that the desired products are currently ‘in stock’ and submits a request for 10000 units of a particular style of Tommy Hilfiger men's exercise outfit. The viewed ‘in stock’ inventory information in this case may be based upon data extracted in real time from the supplier's WMS system. More specifically, the buyer may use the present invention to specify the desired size breakdown (1000 small, 3000 medium, 3000 large, 2000 extra large, and 1000 extra-extra large) of the exercise outfits. The buyer may also specify that Tommy Hilfiger must ship the product by December 15^{th} in order to ensure that the shipment reaches the stores in sufficient time. In addition, the buyer may specify the particular store locations that are to receive the product, as well as the quantity for each store.

Preferably, the system 100 of the present invention carries out such functions as logging the buyer's detailed request into a database for future viewing, automatically transmitting the information about the request to the appropriate personnel within the Hilfiger organization, and sending the request in the form of an XML document to Tommy Hilfiger's ERP system for creation of a purchase order (PO). In one embodiment, notifying personnel within the Hilfiger organization includes capturing the data in an XML format, converting it to an e-mail format, and routing it to the appropriate sales manager in the Tommy Hilfiger organization (in this example, the manager who handles the Macy's account).

Once the ERP system receives the order and performs certain validations, it then preferably sends a document, perhaps in a ‘flat file’ format (i.e., having a single line for each entry, for example) or other simple format, back to the tool indicating the acknowledgement of the PO. In one embodiment, the format consists of single lines with fields having comma-separated values (CSV). The system 100 may then accept this acknowledgement, log it for users to view, convert it to an XML document, route the XML document to the retailer's merchandising system and/or perform other desired functions.

On the supplier side, an administrator (e.g., sales manager) at the supplier location preferably receives notification, such as by e-mail, that an order has been placed. The sales manager may then log into the system 100 (e.g., using a PC with an Internet browser) in order to investigate the availability of the specified products. Upon logging in, the system 100 preferably identifies that there is an open request for the sales manager and visually alerts him to this condition by displaying an exception message/condition.

Just as the Tommy Hilfiger customers (i.e. retailers and/or others) are preferably controlled in their access to information, the sales manager preferably can only view incoming requests from Macy's, assuming for purposes of this example that Macy's is the only client the manager supports. In examining the request, the sales manager may view the actual inventory for the specified products and can confirm that 10,000 pieces are indeed available to promise (ATP) to Macy's within the specified timeframe.

The sales manager may also use the browser interface to the system 100 to indicate that he or she has reviewed the request and approved it. In this process the system 100 preferably updates the request in the database, and generates an XML document, for example, for the supplier's ERP system indicating that the sales manager has reviewed and approved the order. When the Macy's buyer next logs into the system 100 to check on a status of the order, the buyer is preferably presented with data indicating that the order was acknowledged and subsequently approved.

So far, a series of relatively straightforward business transactions/decisions have been described. Next, the example continues as an illustration of a manner in which the present invention enables trading entities to adapt to changed conditions. Assume that, within the next week, the Macy's buyer receives further sales data indicating that certain stores in Florida will actually need a total of 1000 more units. In addition, the buyer learns that the order must begin shipping to Macy's a week earlier than was originally indicated.

To convey this information, the buyer may log into the system 100 and access the original order. The buyer can also check availability of the additional product. It is assumed for purposes of illustration that the system 100 indicates that there are currently not enough products in stock to fulfill the additional demand. Regardless, the buyer inputs the additional quantities, specifies which stores should receive the additional product, and indicates the new date the product is needed. As discussed above, the buyer has authority (controlled using the tool's security model) to make the changes to this order based upon the buyer's credentials. The system 100 preferably captures the updates in a database and immediately transmits the updated information, such as by an XML document, to Tommy Hilfiger's ERP system. The system 100 may also send an e-mail document or other notification to the sales manager (as described previously).

On the supplier side, upon receiving the change notification, the sales manager preferably again logs into the system 100 to view the updated order. Of course, the manager, and any other party in this example, may alternatively be continually logged in. Regardless, the manager is preferably able to see that, in this example, there is not enough inventory currently in stock to fulfill the additional 1000 units. However, the manager, using the present invention, can access current manufacturing information for the primary manufacturer of these particular products, which has several factories located primarily in Mexico.

Preferably, the system 100 obtains information about the current manufacturing orders and the capacities in real time. In one embodiment, the information is based upon a combination of information in the manufacturing system and in the ERP system. Again, the system 100 can preferably extract information from both of these systems, which may be running on different platforms with different databases. The system 100 can preferably format the information into an XML or other acceptable format, and present it to the sales manager, such as through an Internet browser or other communications interface on the manager's system. In this manner, the sales manager is able to check on a status of the product for Macy's. Assuming that the order has not yet begun manufacturing, the manager preferably uses the system 100 to initiate a request for a change to the original manufacturing order. This request may be captured in a database and made available to the manufacturer via the browser or other communications interface. Preferably, like other users of the system 100, the sales manager's ability to make a request for a change to the manufacturing will be dependent on the authority granted to his or her ‘profile’ through the relevant security model.

At the manufacturer's organization, it is assumed that a manufacturing manager is in charge of handling new requests. Typically, depending on a particular security model used, this manager will be the one of few people or the only individual in that organization with authority to view these requests from buyers. The manager may even have complete access to manufacturing information across all of the factories. Alternatively, the manufacturing manager's function, like most functions herein disclosed, may be automated. For example, where manufacturing is processor controlled or otherwise automated, additional manufacturing may automatically occur in response to the received request.

To illustrate a flexibility of the present invention, it is assumed that, due to technological constraints, the factories have no independent systems (e.g. ERP, WMS, etc). Nonetheless, through use of the highly configurable, real-time, data extraction layer of the system 100, manufacturing personnel at the factories can still share information with their customer (Tommy Hilfiger). In one embodiment, they may use even a basic PC with an Internet browser (and an Internet connection).

Preferably, the manufacturing manager accesses the system 100 and immediately receives visual notification of a new request. The manufacturing manager can then access the request and the related order. Upon analyzing the request and obtaining the necessary information from the factory production managers, the manager is able to determine whether the factory will be able to provide the additional product within the timeframe indicated. The manager can then use the browser or other acceptable interface to input this information into the system 100 and immediately respond to the request. Upon responding to the request, the system 100 preferably sends notification, such as through an XML transaction, preferably to Tommy Hilfiger's ERP system notifying it of the event. The system 100 preferably also updates the additional request in its own database to indicate that it has been ‘accepted.’

At the retailer, the sales manager can use the present invention to monitor the status of the modified request. As soon as it appears as ‘accepted’ by the manufacturer, the manager can use the system 100 to approve the request. The system 100 then preferably records the approval by the sales manager (which the retail buyer can also view immediately through the system 100), and submits an XML document or other acceptable notification, preferably to the Hilfiger ERP system, for acknowledgement of the updated order.

Once the updated order is acknowledged by the supplier's ERP system, this acknowledgement information (for the updated order) can be sent through the system 100 to the retailer's merchandising system. This information is preferably in the form of an XML document created by the system 100, but can be in any desired format. In addition, the system 100 preferably processes the order acknowledgement, generates a corresponding notification, such as an e-mail document, and routes the notification to the retail buyer. The retail buyer is thereby able to receive visual notification of the acknowledgement of the revised order through the system 100. This on-line, real-time notification may be the only notification, or may be in addition to receiving a corresponding notification by e-mail or other suitable means.

Returning again to the factory side, the factory can use the system 100 of the present invention to continuously report quantities of product produced and provide status updates to the order. These updates may occur periodically, such as daily, or at any desired times. The updates may even be automated, as part of the manufacturing process, for example. Where orders are of a time sensitive nature, as may often be the case, the sales manager, or any other user of the present invention for that matter, has the ability to place an alert on the order. That is, the system 100 may monitor order quantities input by the factories, and may be programmed to notify the manager upon an occurrence of any selected condition or conditions. For example, the manager may seek notification that the order is 80% complete but there are only 3 days remaining to complete the remaining 20%. The alerts may be visual (e.g., presented to the sales manager upon logging into the tool) and/or electronic, such as by e-mail. Other potential notification means here and throughout the system 100 include a public address (PA) announcement throughout the facility, pop-up message, paging to a cell phone, pager or personal digital assistant (PDA), etc.

Made possible in this example by the real-time nature of the information available, the sales manager may make last minute changes to the order. For example, so as to compensate for some of the delay in the manufacturing process, the sales manager may decide to ship the product from the supplier's distribution center (DC) via an express transportation carrier instead of the normal carrier. Preferably, these carriers are also interfaced with the system 100 of the present invention. This change could compensate for the delay and allow the product to arrive on time at the retailer's DC. The manager is able to make this change by using the system 100 to specify the new shipping information. The system 100 can in turn notify the new express transportation carrier (again, such as via an XML transaction sent to the carrier's system) of the need for its services.

Upon receiving the request for its services, the transportation provider is able respond back through the system 100 with an acknowledgement, which the system 100 preferably processes and makes visible to the supplier. As soon as the sales manager views that the express carrier has agreed to deliver the product, the sales manager can notify the operations department so that they can, for example, adjust the manpower in the receiving area at the distribution center based upon the new 2-day delay.

While the order is en route from the manufacturer to the supplier's DC, the system 100 allows multiple parties to provide and receive additional order information. This may occur, for example, by accessing the system 100 and viewing or inputting information (if the supplier or other relevant party has given these accessing parties authority to do so). Input information may be in a form of a systemic transaction (e.g. flat file, XML), or by posting an update on a web site. In one embodiment, such web site postings are automatically extracted and converted to an acceptable format by the system 100. Exemplary additional parties that may provide or be allowed access to this information include a freight forwarder, a freight consolidator, a customs brokers, a customs agency, a freight de-consolidator, retail customers, etc.

Once the express carrier takes ownership of the product, it may post updates, at any desired time or times, to order tracking information accessible from the carrier's web site and/or via the system 100. The sales manager is further able to user the system 100 to directly access this information, allowing him or her continuous visibility to the order while it is en route to the retailer's DC. Likewise, the retail buyer may access the system 100 to check on the order, and will preferably see the same information (in our example, that the order is approximately 2 days from arrival).

As another variation, assume that, during the second day that the product is on its way to the retailer's DC, the truck containing the Macy's order breaks down. The driver preferably notifies the carrier of this event. Notification may be direct, or may be through the system 100, such as via a wireless Internet connection or other means. Upon receipt of the notification, the carrier preferably dispatches a new truck and posts the relevant information (new truck number, time of dispatch, etc.) to the system 100, such as through its web site.

In tracking progress of the shipment, the sales manager is preferably informed in real time of the disruption in the shipping information. By checking the details, the manager is able to learn that a new truck has already been dispatched. The system 100 preferably obtains this detailed information in real time by extracting information posted by the express carrier. Ideally, the sales manager learns that the order should arrive at the retailer's DC on time, in spite of the change of trucks.

The retail buyer can continue to use the system 100 to monitor the shipment, based upon extracting frequent updates made by the express carrier to its own web site, until the shipment arrives at the DC. In addition, the manager is able to access the system 100 for any other information that users of the system 100 desire to include. For example, the manager could log in and view an image of the relevant Bill of Lading, indicating exactly when the DC personnel signed the document to take ownership of the product and begin receiving. By enabling the type of collaborative, real-time exchange of supply chain information described in the above example, the system 100 is able to greatly improve an efficiency, visibility and adaptability of trading partner transactions.

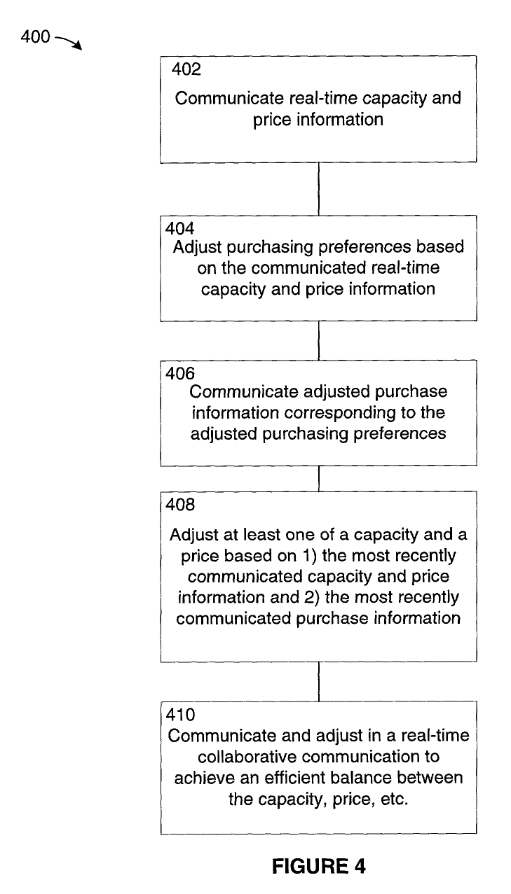

With reference to FIG. 4, an embodiment of a method 400 of the present invention will be described. The method 400 allows integrated information exchange between trading partners conducting a transaction. In this embodiment, the transaction is assumed to be a sale, and may be from a manufacturer to a wholesaler, from a wholesaler to a retailer, from a manufacturer directly to a retailer, etc. The subject of the sale may be a product, service, option, etc.

Regardless of the transaction and entities involved, this embodiment of the method 400 includes a step 402, in which a first trading partner communicates to a second trading partner, preferably over a network, real-time capacity and price information for the subject of the sale by the first trading partner. In a step 404, the second trading partner adjusts its purchasing preferences based on the real-time capacity and price information communicated by the first trading partner. In a step 406, the second trading partner communicates adjusted purchase information corresponding to the adjusted purchasing preferences of the second trading partner to the first trading partner. In a step 408, the first trading partner adjusts at least one of a capacity and a price based on 1) the capacity and price information of the first trading partner most recently communicated by the first trading partner, and 2) the purchase information of the second trading partner most recently communicated to the first trading partner.

Finally, in a step 410 which may be repeated as necessary, the first trading partner and the second trading partner continue communicating and adjusting in a real-time collaborative communication over the network to achieve an efficient balance between the capacity, price, supply, etc., of the first trading partner and the purchase information or demand of the second trading partner. In this manner, trading entities may make efficient use of the network, and technology and functionality of the present invention, to more easily, quickly and accurately reach a price and quantity most suitable to both parties.

Of course, numerous variations of the method 400 are contemplated. For example, the information exchanged between trading partners may often relate to a product, but may also relate to a service or another item or items, an option to buy or sell, or any combination thereof or others. The information may concern previously exchanged items, or items to be exchanged in the future. The information need not be communicated directly from one trading partner to another, as one or more intermediaries may be involved. And again, the term ‘partners’ need not connote any agreement or common interest between the parties, as the trading partners may be any entities, adverse or otherwise, desiring to provide information to or receive information from the system 100.

Regarding an adjustment of purchasing preferences, a trading partner may adjust a price it is willing to pay based on a variety of factors. For example, the trading partner may adjust price based on a demand and/or real-time capacity and price information received from another trading partner. Similarly, the adjustment of at least one of a capacity and a price of an item may be based on a number of factors, and may take place in a variety of ways. Adjusting the capacity of a product, for example, may include generating at least one additional unit of the product from available raw materials. And this adjustment may be based on purchase information most recently received.

In another embodiment, a first trading partner may further adjust price or capacity of or purchasing information for an item based not only on information exchanged with a second trading partner with whom the first trading partner wishes to deal, but also on information of a third party. For example, a trading partner may adjust price based on a known market price. The adjustment may also be based on information of another trading partner, such as where a wholesaler adjusts purchasing preferences based on real-time capacity and price information communicated by a manufacturer and purchasing preferences communicated by a retailer, for example. Likewise, a retailer may adjust purchasing preferences based on the real-time capacity and price information communicated by a manufacturer and purchasing preferences communicated by a wholesaler to the manufacturer. As discussed below, the wholesaler in such an embodiment may control a degree to which the third party retailer has access to information regarding a transaction between the wholesaler and the manufacturer. And as noted above, this control includes an absolute control to information, as well as control of a nature and quality of information as viewed by a particular entity.

The method 400 described also need not include all steps described, and may include additional steps. For example, a trading partner may further selectively grant to third parties access to the purchasing preferences and other information communicated to entities to whom the trading partner is dealing. For example, a manufacturer, a wholesaler or a retailer may selectively grant to any or all other manufacturers, wholesalers and retailers, access to supply chain information of the respective manufacturer, wholesaler or retailer. In one embodiment, the selectively granting includes granting graduated access to multiple levels of the supply chain information based on a status of a requestor of the information. For example, the requesters may be assigned to any of a number of predefined classes of manufacturers, wholesalers, retailers or others. The granting of graduated access may further be based on a condition of a possessor of the information with regard to any supply chain or other information.

Conclusion

While various embodiments of the invention have been described, it will be apparent to one skilled in the art that many more embodiments and implementations are possible that are within the scope of this invention. The present invention may be practiced between any desired entities. For example, as discussed above, while the phrase trading ‘partner’ is used, no agreement or other relationship is necessary between entities. The invention may provide a means to carry out a transaction, such as a sale or exchange of any products or services, or may be used merely for information sharing. Furthermore, the present invention is not restricted to use with the Internet or any hardwired system, but may alternatively be practiced on any network, physical, wireless or otherwise. Accordingly, the invention is not to be restricted except in light of the attached claims and their equivalents.

What is claimed is:

1. A method for real-time supply chain management over a network, comprising:
by a manufacturer, communicating to a wholesaler or retailer real-time capacity and price information for a product of the manufacturer;
by the wholesaler or retailer, adjusting purchasing preferences of the wholesaler or retailer based on the real-time capacity and price information communicated by the manufacturer;
by the wholesaler or retailer, communicating adjusted purchase information corresponding to the adjusted purchasing preferences of the wholesaler or retailer to the manufacturer;
by the manufacturer, adjusting at least one of a capacity and a price of the product based on 1) the capacity and price information for the product of the manufacturer most recently communicated by the manufacturer, and 2) the purchase information of the wholesaler or retailer most recently communicated to the manufacturer; and
by the manufacturer and by the wholesaler or retailer, repeating as necessary said communicating and said adjusting in a real-time collaborative communication to achieve an efficient balance between the capacity and price of the manufacturer and the purchase information of the wholesaler or retailer.

2. The method of claim 1, wherein said adjusting purchasing preferences includes adjusting a price the wholesaler or retailer is willing to pay based on a demand of the wholesaler or retailer and the real-time capacity and price information received from the manufacturer.

3. The method of claim 1, wherein said adjusting at least one of a capacity and a price of a product includes adjusting the capacity of the product by generating at least one additional unit of the product from available raw materials based on the purchase information of the wholesaler or retailer most recently communicated to the manufacturer.

4. The method of claim 1, further comprising:
by one of the manufacturer, the wholesaler and the retailer, adjusting price or capacity of or purchasing information for a product based on information communicated between the other two of the manufacturer, the wholesaler and the retailer.

5. The method of claim 1, further comprising:
by the wholesaler, adjusting purchasing preferences of the wholesaler based on the real-time capacity and price information communicated by the manufacturer and purchasing preferences communicated by the retailer.

6. The method of claim 1, further comprising:
by the retailer, adjusting purchasing preferences of the retailer based on the real-time capacity and price information communicated by the manufacturer and purchasing preferences communicated by the wholesaler to the manufacturer; and
by the wholesaler, selectively granting to the retailer access to the purchasing preferences communicated by the wholesaler to the manufacturer.

7. The method of claim 1, further comprising:
by the manufacturer, the wholesaler or the retailer, selectively granting, to any or all others of the manufacturer, the wholesaler and the retailer, access to supply chain information of the respective manufacturer, wholesaler or retailer.

8. The method of claim 7, wherein said selectively granting comprises:
granting graduated access to multiple levels of the supply chain information based on a status of a requester of the information in any of a number of predefined classes of manufacturers, wholesalers, retailers or others.

9. The method of claim 8, wherein said granting graduated access is further based on a condition of a possessor of the information with regard to such supply chain information as purchasing preference and demand for, and price and capacity of, a product.

10. A system for real-time collaboration between a manufacturer, a wholesaler and a retailer over a network, comprising:
a manufacturer portion, a wholesaler portion and a retailer portion, said manufacturer portion, said wholesaler portion and said retailer portion being in communication via the network;
wherein said manufacturer portion, said wholesaler portion and said retailer portion are enabled for a real-time exchange of supply chain data.

11. The system of claim 10, wherein the supply chain data exchanged in real time between said manufacturer portion, said wholesaler portion and said retailer portion includes at least one of: a capacity of a product or service of the manufacturer or wholesaler, a price of a product or service, and a demand by the wholesaler or retailer for a product or service.

12. The system of claim 10, wherein at least one of said manufacturer portion, said wholesaler portion and said retailer portion is configured as an industry portal.

13. The system of claim 10, further comprising:
a data extraction layer, coupled to at least one of said manufacturer portion, said wholesaler portion and said retailer portion, for facilitating communication between the respective portion and remaining portions of the system.

14. The system of claim 13, wherein said data extraction layer comprises a back-end interface for extracting raw data from the portion to which said data extraction layer is coupled and converting the raw data, in real time, to a format readable by remaining portions of the system.

15. The system of claim 14, wherein said data extraction layer further comprises a pull system for translating data from a format of a legacy system of the portion to which said data extraction layer is coupled to an Extensible Mark-Up Language (XML) format.

16. The system of claim 14, wherein said data extraction layer further comprises a pull system for translating plain text data entered via a browser-based interface at the portion to which said data extraction layer is coupled to an Extensible Mark-Up Language (XML) format.

17. The system of claim 10, wherein said manufacturer portion, said wholesaler portion and said retailer portion comprise browser-based interfaces between the respective portions and the network.

18. The system of claim 17, wherein said manufacturer portion, said wholesaler portion and said retailer portion exchange the real-time supply chain data in an Extensible Mark-Up Language (XML) format.

19. The system of claim 10, wherein said manufacturer portion, said wholesaler portion and said retailer portion exchange the real-time supply chain data in an Extensible Mark-Up Language (XML) format.

20. The system of claim 10 wherein said manufacturer portion, said wholesaler portion and said retailer portion comprise a first trading exchange;
the system further comprising one or more further trading exchanges in real-time communication with said first trading exchange.

21. The system of claim 10, wherein said supply chain data includes information relating to at least one of: 1) capacity of a product, 2) demand for a product, 3) price of a product, 4) delivery status of a product, and 5) available substitutes for a product.

22. A method for real-time supply chain management, comprising:
by a buyer, receiving from a seller real-time capacity and price information for a product of the seller;
by the buyer, communicating purchase information of the buyer to the seller based on the real-time capacity and price information received from the seller;
by the seller, adjusting at least one of a capacity and a price of the product based on 1) the capacity and price information for the product of the seller most recently received by the buyer, and 2) the purchase information of the buyer most recently communicated to the seller; and
repeating as necessary said receiving, said communicating and said adjusting, in a real-time collaborative communication, to achieve an efficient balance between a supply of the seller and a demand of the buyer.
